(19) United States
(12) Patent Application Publication
(10) Pub. No.: US 2025/0292747 A1
(43) Pub. Date: Sep. 18, 2025

(54) AUTOMATED CHORD-PRESSING APPARATUS FOR STRINGED MUSICAL INSTRUMENTS

(71) Applicant: Eytan Israel, Stamford, CT (US)

(72) Inventor: Eytan Israel, Stamford, CT (US)

(21) Appl. No.: 19/066,329

(22) Filed: Feb. 28, 2025

Related U.S. Application Data
(60) Provisional application No. 63/565,126, filed on Mar. 14, 2024.

(51) Int. Cl. G10D 3/053; G10H 1/00; H02K 7/075

(52) U.S. Cl. CPC G10D 3/053; G10H 1/0008; H02K 7/075; G10H 2210/576

(57) ABSTRACT

An automated chord-pressing device that attaches to the bridge of an existing stringed instrument and employs a singular camshaft per fret for chord formation, and accompanying software to actuate it and automate chord-pressing while the user strums. The mechanical design is attachable to any existing stringed instrument, avoiding complexity and enhancing portability and ease of use for the end user. An alternative embodiment is disclosed that utilizes magnets to hold down specific strings. Both embodiments are portable and afford user with the opportunity to actively participate and engage in the musical experience, as opposed to passive participation offered by prior art systems, thereby preserving the therapeutic and recreational essence of music creation.

### CROSS-REFERENCE TO RELATED APPLICATION(S)

The present application derives priority from U.S. Provisional Patent Application 63/565,126 filed Mar. 14, 2024.

### BACKGROUND OF THE INVENTION

### 1. Field of the Invention

The present invention relates to assistive musical devices, particularly a device that interfaces with stringed instruments to facilitate playing by individuals with physical or cognitive impairments or who simply do not know how to play.

### 2. Description of the Background

Every person, including those with disabilities, should be given an opportunity to explore and expand their world. To that end there are many applications for assistive technology to help individuals with physical or cognitive impairments experience more, including musical applications. There are many devices and software applications that fully replicate an instrument. For example, the prior art includes various automated mechanisms aimed at enabling individuals with disabilities to engage with stringed musical instruments, including U.S. Pat. Nos. 4,856,404, 7,285,709, 7,285,716, 11,404,035 and 5,393,925, which collectively show various assistive strumming, plucking, and fretting functionalities. However, these patents focus on comprehensive mechanization of the entire musical experience and tend to necessitate significant modifications to the instrument. The high degree of automation eliminates the need for any user interaction, and deprives the user of the physical and emotional experience of actually playing the instrument. This is especially true for stringed instruments, for which the strumming aspect is integral to the tactile and therapeutic experience of playing music.

What is needed is a device that allows user interaction through strumming, while automating chord-playing (fretting) on a stringed instrument. Such as device would foster a more inclusive and active music creation process. Such a device would allow individuals with disabilities, as well as individuals who have a desire to play music but just never had the time to learn the art, to have the opportunity to play music. This wide range of applications, filling a need also within the mainstream community, is also a unique aspect of this device.

### SUMMARY OF THE INVENTION

In accordance with the foregoing it is an object of the invention to foster a more inclusive and active music creation process for individuals with and without disabilities.

It is another object to provide an automated chord-pressing apparatus for stringed musical instruments to facilitate actual participation of individuals with physical or cognitive impairments.

It is still another object to facilitate user interaction through strumming, while automating the chord-playing (fretting) aspect of a stringed instrument.

It is yet another object to provide an automated chord-pressing apparatus that is controlled through an external application which allows remote software updates, including the ability to expand the catalog of strummable song listings.

It is yet another object to provide an automated chord-pressing apparatus that changes chords either at a predetermined tempo, or after each chord that is played using, e.g., piezoelectric sensors to detect strumming.

It is still another object to provide an automated chord-pressing apparatus as described above that is compact, lightweight, economical, and attachable to a pre-existing stringed instrument.

The foregoing and other objects are accomplished with an automated chord-pressing device that attaches to the bridge of an existing stringed instrument and employs a singular camshaft per fret for chord formation, and accompanying software to actuate it and automate chord-pressing while the user strums. The mechanical design is attachable to any existing stringed instrument, avoiding complexity and enhancing portability and ease of use for the end user. An alternative embodiment is disclosed that utilizes magnets to hold down specific strings. Both embodiments are portable and afford users with the opportunity to actively participate and engage in the musical experience, as opposed to passive participation offered by prior art systems. The invention preserves the therapeutic and recreational essence of music creation, making it a unique and significant enhancement to the field.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top view of the automated chord-pressing apparatus 1 according to an embodiment of the invention adapted and attached to a four-string ukulele.

FIG. 2 is a side view of the automated chord-pressing apparatus 1 of FIG. 1.

FIG. 3 is a top end view of the automated chord-pressing apparatus 1 of FIGS. 1-2.

FIG. 4 is an exploded diagram showing the upright support post 7 of FIGS. 1-3 as it receives a servo motor 2, and a camshaft 3 configured for attachment to the existing torsion arm of the servo motor 2. It also displays how the lobes 4 are placed along the camshaft 3.

FIG. 5 is an exploded diagram of a single piston 9 of FIGS. 1-3.

FIG. 6 illustrates an exemplary collar 7 for securing the base 12 to the neck of the ukulele.

FIG. 7 is screen print of the software musical dashboard.

FIG. 8 is block diagram of the software process underlying the musical dashboard of FIG. 7.

FIG. 9 is a side view of a magnetic embodiment of the invention.

FIG. 10 is a top view of the magnetic embodiment of FIG. 9.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is an automated chord-pressing device 1 that attaches to the bridge of a stringed instrument, plus a software application in communication therewith that actuates the device to automate chord-pressing while the user strums along. The device is attachable to any existing stringed instrument.

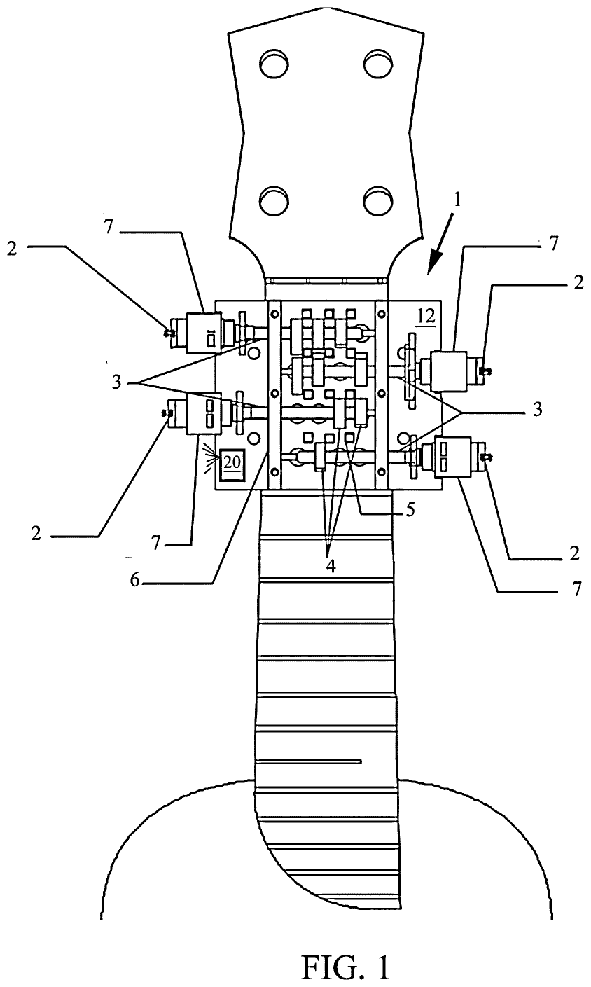

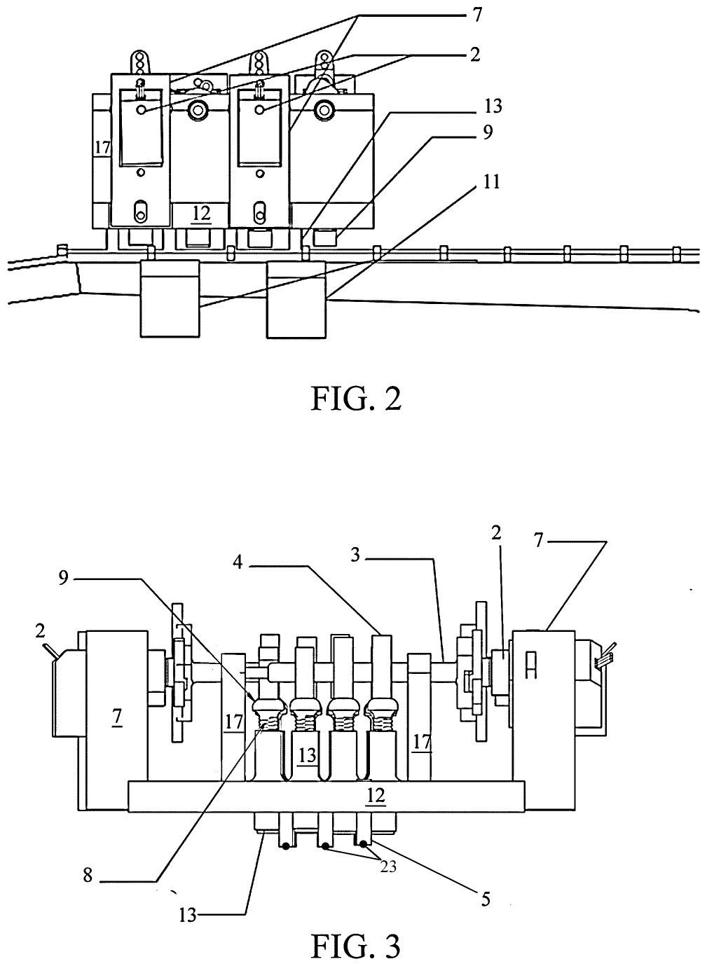

FIGS. 1-3 illustrate an embodiment of the chord-pressing device 1 attached to and configured for chord-formation on an existing four-stringed ukulele. One skilled in the art should understand that the device is scalable and may be adapted for any stringed instrument having any number of strings. The chord-pressing device 1 employs a plurality of camshafts 3, one for each of four frets for chord formation, four camshafts 3 total, each camshaft being servo-controlled by a corresponding end-mounted servo motor 2. Each camshaft 3 carries up to four eccentric lobes 4. Thus, on top of each string, there lies an eccentric lobe 4 whose major axes R bear downward against a spring-loaded piston 9, effectively driving the piston 9 downward into the underlying string to form a note which the user strums, when the camshaft 3 is set to specific angles. Lobes 4 preferably employ an oval or other eccentric cross-section with at least one major axis R′, or multiple major axes R′, R″, etc. as best seen in FIG. 3. Each lobe 4 can be rotated on camshaft 3 so as to bring each major axis to bear downward against a spring-loaded piston 9, effectively driving the piston 9 downward into the underlying, changing the note that will be emitted when the string is strummed. Four lobes 4 can be rotated on four camshafts 3 to drive up to four pistons 9 downward into four underlying strings to form a multi-note chord, which the user strums. The lobes 4 may be angularly positioned such that any or all major axes R may be pointed down at once. Accompanying software (to be described) can be programmed to play individual chords, or to play an entire song at a set tempo to fully automate chord-pressing while the user strums along. The device 1 is attachable to any existing stringed instrument, avoiding complexity and enhancing portability and ease of use for the end user. The servo motors 2 are held in upright support posts 7 that are attached to an underlying base 12. Camshafts 3 are also journaled through upstanding partitions 17 attached to base 12 which rotatably cradle and support camshafts 3 so as to straddle the strings above the bridge. The spring-loaded pistons 9 protrude downward beneath the base 12 for detent-depression of the strings. The base 12 may be secured by clamping collars 7 to any existing four-string ukulele for operation. Camshafts 3 effectively convert indexed rotational motion of the servo motors 2 into indexed linear depression of the pistons 9, which apply force to the strings of the ukulele. Each camshaft 3 has four equally-spaced lobes 4, and the four lobes 4 across each camshaft 3 are angularly-offset at different angles, allowing any combination of four different strings to be held down or not based on the rotation of the servo 2. Thus, for example, to play a G chord on the ukulele, the second fret (from top) would have its second and fourth strings depressed, and two lobe 4 are rotated downward against pistons 9 atop fret 2. Conversely for a C no strings are pressed on the second fret. For an A chord just the first string is depressed. To accomplish the foregoing, the second fret camshaft 3 at 0-degree rotation would not orient the major axis of any lobes 4 downward to the strings; at 60-degree rotation the second fret camshaft 3 would orient the major axis of two lobes 4 (for second and fourth strings) downward to the strings; at 120-degree rotation the second fret camshaft 3 would orient the major axis of one lobe 4 (for the first string) downward to the strings. Thus, when a C is played, the second servo 2 goes to 0 degrees. When a G is played, the servo 2 goes to 60 degrees. When an A is played the servo 2 goes to 120 degrees. The user need only strum the chords.

The four servo motors 2 are held captive in the four upright support posts 7 all anchored to base 12, all directed inward, and equally offset such that the rotor of each servo 2 is coaxially aligned above one of four adjacent instrument frets. A micro-controller 20 (MCU) drives all servo motors 2 with a PWM (pulse-width modulation) signal. In the illustrated embodiment the micro-controller (MCU) 20 presently employed is an Arduino™ board design capable of cross-referencing a desired chord to a servo angle and directly outputting a proper PWM signal to achieve that angle (no servo controller necessary). However, one skilled in the art will understand that other suitable programmable controllers or programmable logic controllers (PLU), with or without servo controllers may also suffice.

The spacing of the piston sleeves 13 and base 12 from the neck of the ukulele can be maintained by spacer stands 5 which avoid muting of the strings. The support posts 7 and spacer stands 5 are dimensioned to allow the pistons 9 to hover directly above the strings when in their spring-biased resting position, and yet sufficiently press down on the strings in their extended position to create a strong and defined chord.

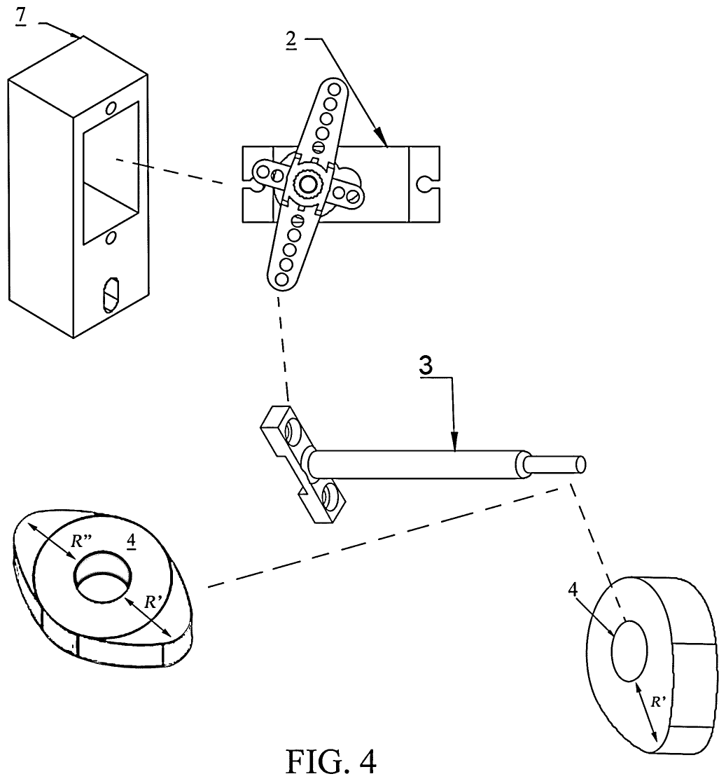

FIG. 4 is an exploded diagram showing an upright support post 7 as it receives a servo motor 2, and a camshaft 3 configured for attachment to the existing torsion arm of the servo motor 2. Each support post 7 is a rectangular member with front-facing alcove adapted to seat and secure a corresponding servo motor 2 by screws or the like. If necessary, a servo-motor controller may be screw-mounted opposite or provided as an integral part of the servo motors 2. The four support posts 7 are attached to the main platform 12 at offset positions as shown in FIG. 1 such that the rotors of the inserted servo motors 2 are oriented outward above the strings along each of the four frets. This way, when camshafts 3 are mounted to the servo motors 2 the four camshafts 3 straddle all four strings each along a corresponding fret. The camshafts 3 are preferably journaled through and supported by upright partitions 17 attached to base 12 which minimize friction yet hold the camshafts 3 tightly in place. Servos 2 may be any suitable indexed-rotation motor, preferably low voltage 5V or 3.3V compatible with a standard controller and with an output shaft bearing a servo arm attachable to a respective camshaft 3. Although the preferred embodiment employs digital-control servo motors 2 one skilled in the art will understand that an analog step-motor will also suffice. Presently, Beffkkip™ MG90S micro servo motors are being used with a 4.8V DC input voltage.

Referring back to FIG. 4 each camshaft 3 carries a plurality of eccentric lobes 4 along an axis of rotation, each lobe 4 preferably having an eccentric cross-section such as oval with at least one major axis R disposed radially with respect to the axis of rotation as described above. The support posts 7 are positioned to orient camshafts 3 along the respective frets, and the lobes 4 are equally-spaced along the respective camshafts 3 so that their major axis can bear downward against a spring-loaded piston 9, effectively driving the piston 9 into a string.

Referring back to FIG. 3, each piston 9 comprises a cylindrical pin with enlarged head spring-loaded by a compression spring 8 into a hollow tubular sleeve 13 protruding both upward from base 12 and downward below base 12. The matrix array of sleeves 13 positions the head of each piston 9 directly underneath a corresponding lobe 4, such that the piston 9 is progressively depressed as the lobe's major axis rotates increasingly downward. Each camshaft 3 carries up to four eccentric lobes 4 along a single axis of rotation, and these lobes 4 are oriented atop corresponding detent pistons 9 that bear against the corresponding strings atop a single fret. This way each spring loaded piston 9 effectively drives one string against that fret to play a note. As a matter of design choice, not all camshafts 3 necessarily carry four eccentric lobes 4. This is because common ukelele chords do not use all four strings along every fret. For example, while common ukelele chords do indeed utilize all four strings along second fret, common chords do not use all four strings along fourth fret (the right-most or 1^{st} string is not often used) and so there may only be three lobes along the fourth fret.

The lobes 4 across each camshaft 3 may be angularly-offset at different angles or not, as desired. Indexed rotation of the servo motor 2 orients all lobes 4 along one fret as needed to allow any combination of different strings to be held down, or none at all, along that fret. Different chord combinations using multiple frets/servos 2 are possible at any given tempo, and the user need only strum the chords at that tempo. Alternatively, the MCU 20 may be set to detect when a strum is finished and then switch to the next chord based of that detection and not a set time interval. To realize seamless chord transitions in response to strumming actions (as opposed to a predetermined tempo), Piezoelectric sensors can be used to detect a user's strum. FIG. 3 illustrates in which a plurality of piezoelectric sensors 23 are embedded, one each distally in each spacer stand 5 proximate corresponding string. The piezoelectric sensors 23 are in communication with the MCU 20 and are configured to detect mechanical vibrations, exploit the piezoelectric effect to convert vibrations into discernible electrical signals, and transmit same to the MCU 20. The MCU 20 executes software (described below) that performs signal analysis to decipher strumming patterns and distinguish intentional strums from incidental touches. This software analysis establishes the framework for initiating chord transitions in response to the user's strumming, as opposed to a pre-programmed tempo. The MCU 20 software monitors string vibration, identifies the opportune juncture for chord switching, and orchestrates seamless communication with the servo motors 2 (alternatively electromagnets 33 described below) governing the chord-pressing mechanism. While the option to change chords based on time intervals would better benefit less skilled individuals have the incredible feeling of creating music, this option gives more advanced users who perhaps cannot play the regular instrument due to physical disabilities, a way to truly gain control and ownership of the playing experience.

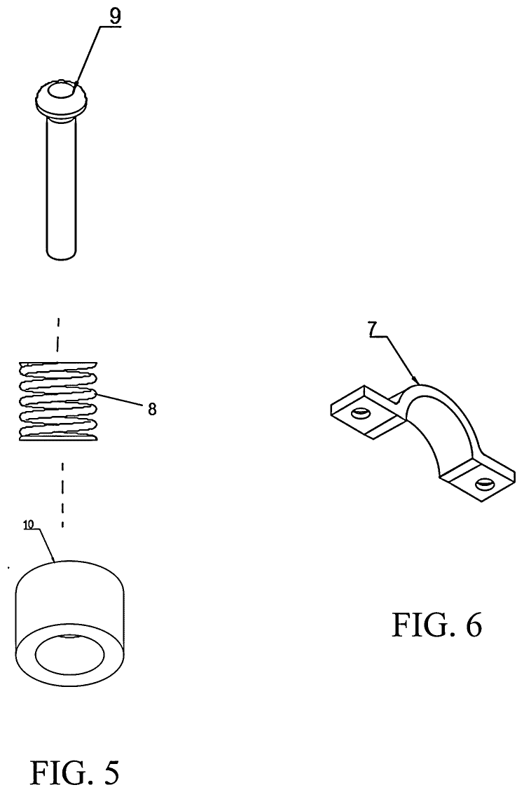

FIG. 5 is an exploded diagram of a single piston 9 configured as a cylindrical pin with enlarged head spring-loaded by a compression spring 8 into a hollow tubular sleeve 13 protruding upward from base 12.

FIG. 6 illustrates an exemplary collar 7 for securing the base 12 to the neck of the ukulele. Collar 7 is a U-shaped clamp that seats the neck of the ukulele and provides flanges on opposite sides of the neck for securing the base 12 thereto atop the neck. The collar 7 is non-invasive, preserves the integrity of the instrument, and allows for quick attachment and detachment. Thus, the automated chord-pressing device 1 is as portable as the ukulele itself. One skilled in the art will understand that collar 7 may be replaced by other suitable components for securing the base 12 to the neck, such as clamp(s), a snap-fit interlock, or any other suitable device that provides for easy connection and removal.

In operation, each servo motor 2 is precisely calibrated to rotate a dedicated camshaft 3 by a desired angular increment using a particular digital code. Each code is correlated with a particular chord by the higher-level micro-control unit (MCU) 20 mounted on the base 12 that stores a cross-reference lookup table. The MCU 20 is in communication with a remote device running a software application described below.

The MCU 20 is preferably built into the collar 7 or base 12 and is electrically connected to all four servo motors 2 for programmed operation. The microcontroller module 20 includes a receiver for wireless receipt of instructions, preferably a Bluetooth (or Wi-Fi) receiver, from a software application (described below), conversion of each chord to a particular PWM signal for establishing servo angle, and distribution of the PWM signals to the appropriate servo motors 2 at the appropriate tempo.

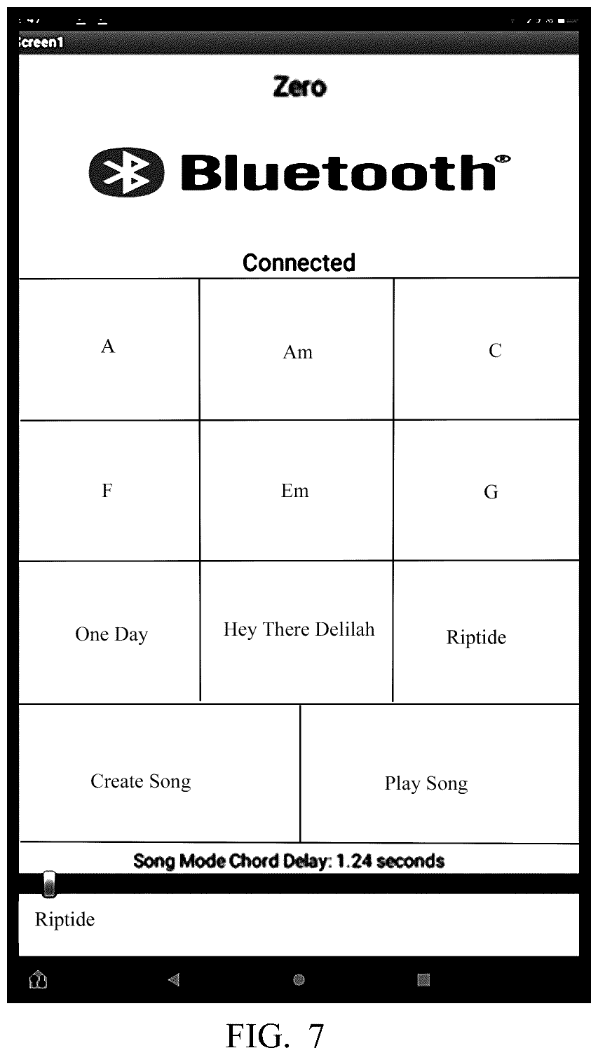

FIG. 7 is screen print of the musical dashboard that includes several sequential screens for implementing the present software. The musical dashboard includes a variety of selectable chords and songs, as well as a Bluetooth connection indicator, a “Create Song” button, “Play Song” button, and chord delay slider control. To play a chord a user (simply) selects the chord's name, e.g. “F”. The dashboard correlates the selected chord to chord number 1-15. The chord number is transmitted by Bluetooth to the MCU 20 and is distributed to the appropriate servo motors 2 to play the chord. For example, if chord “F” is chosen the dashboard transmits chord #4, and the MCU 20 directs servo 1 to 0 degrees. Servo 2 to 60. Servo 3 to 120, and Servo 4 to 0. If a user wants to input their own song or series of chords, they can click “create song” and select the chords they want to play one after another. The chords are added one by one to the queue. The user then sets their desired tempo using the slider control, and hits “Play Song”. The song is transmitted by Bluetooth to the microcontroller module 20, is converted to a timed sequence of digital codes corresponding to the song and is distributed to the appropriate servo motor 2 to play the song at the selected tempo. To play a song a user selects the song, e.g. “Hey There Delilah”, sets their desired tempo using the slider control, and hits “Play Song”. The song is transmitted by Bluetooth to the microcontroller module 20, is converted to a timed sequence of PWM signals corresponding to the song, and is distributed to the appropriate servo motors 2 to play the song at the selected tempo. The user's interaction with the ukulele is through strumming, which can be performed with any standard plectrum or by hand. This strumming action is purely manual, ensuring that the user remains an active participant in the music creation process. It is the combination of the automated chord formation and the manual strumming that defines the unique tactile and auditory experience provided by the invention. This strumming allows for a therapeutic experience for the user as their movements create auditory sensations. Additionally, it allows individuals to work on their fine motor skills and sense of rhythm.

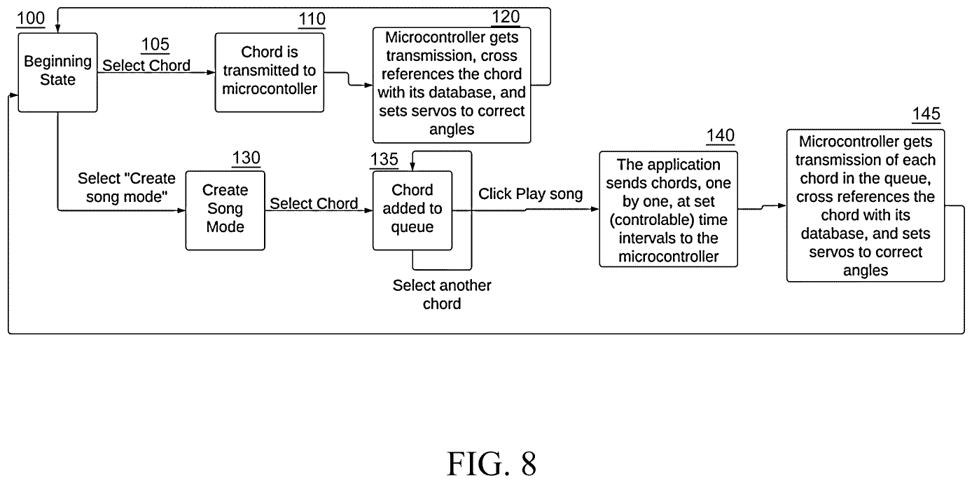

FIG. 8 is block diagram of the software underlying the musical dashboard of FIG. 7. Beginning at step 100, the application has two modes: 1) discrete chords; and 2) songs. In chord mode, at 105 a user selects a chord using the dashboard of FIG. 8, and at step 110 the application transmits a signal to the MCU 20 detailing which chord was selected. At step 120 the MCU 20 cross references the chord with its database to determine the angles each servo motor 2 should be set to, computes the PWM signal needed to attain the angle(s), and outputs the PWM signals to the servos 2 to initiate the sequential actuation of the camshafts 3 to form the desired chords. Similarly, in song mode the user can click the name of a song using the musical dashboard of FIG. 8 and set the tempo slider, and the same above-described sequence is repeated to play the entire song at the selected tempo. As before, the MCU 20, upon receiving each signal, cross references the chord with its database to determine the angles each servo motors should be set to, initiating the sequential actuation of the pistons to form the desired song. Alternatively in song mode, the user can enter “Create Song” mode at step 130, and at step 135 begin adding chords to a queue. This process can be repeated as desired until a complete song has been composed, at which point they can set the tempo slider and hit “Play Song.” At step 140 the application sequentially transmits each chord to the MCU 20 at the desired tempo. At step 145 the MCU 20 cross references the chords with its database to determine the angles each servo motor 2 should be set to, computes the PWM signal needed to attain the angle(s), and outputs the PWM signals to the servo motors 2, all at the selected tempo. This initiates the sequential actuation of the camshafts 3 to form the desired chords to play the newly-composed song.

An alternative embodiment utilizes an array of magnets to hold down specific strings rather than servos 2, camshafts 3 and nodes 7. In the alternative magnetic embodiment, electro-magnets replace servos 2, camshafts 3 and lobes 4 atop a similar platform 12 with array of pistons 9, springs 8 and sleeves 13.

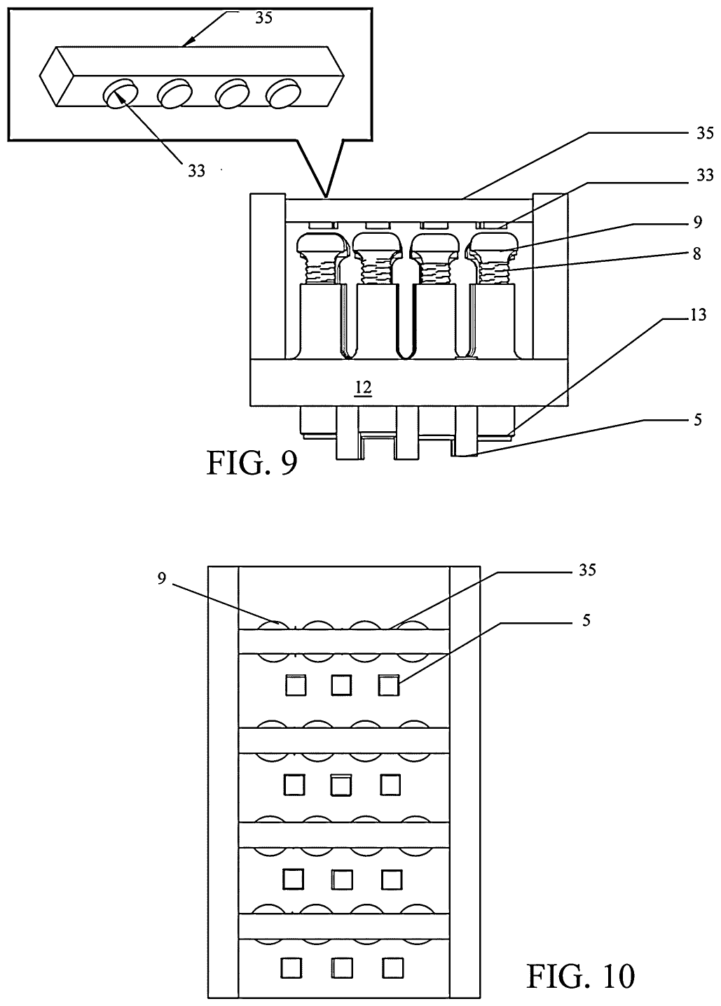

FIG. 9 is a side view of the magnetic embodiment with platform 12, pistons 9, springs 8 and sleeves 13 all as described above, and FIG. 10 is a top view. In this instance each piston 9 comprises an enlarged magnetic-metal head spring-loaded by a compression spring 8 into a hollow tubular sleeve 13 protruding upward from base 12. A plurality of electromagnets 33 are supported or embedded in a crossbar 35. Each electromagnet 33 is meticulously spaced along crossbar 35 (shown in enlarged inset) above a given piston 9 and string, and is calibrated to exert precise magnetic forces upon the piston 9 so as to drive it downward, collectively holding specific strings against the fretboard to form chords. In this version, there is one electro-magnet 33 positioned above every single string in each fret. This allows for any possible combinations of strings held down, widening the number of chords that can be created. The electromagnets 33 are controlled by a like microcontroller MCU 20, in this instance outputting voltage signals to the coils of electromagnets 33 sufficient to actuate the pistons 9. This embodiment enables more rapid and accurate manipulation of the pistons 9, and greatly reduces the space the device 1 takes up since there are no moving servos 2 or camshafts 3. This also eliminates the noise that servo motors 2 create, allow for more control regarding which strings are depressed, and allows for more rapid chord switching. One skilled in the art will understand that electromagnets 33 may be deployed in such as way as to exert force directly on the strings, eliminating the need for pistons 9, or alternatively to pull pistons 9 (or the strings) from below instead of pushing from above. All the foregoing accomplish the same result with only minor variation and are considered within the scope and spirit of the invention.

It should now be apparent that the above-described embodiments are both attachable to any existing stringed instrument and afford user with the opportunity to actively participate and engage in the musical experience, as opposed to passive participation offered by prior art systems. The invention preserves the therapeutic and recreational essence of music creation, making it a unique and significant enhancement to the field.

It should also be apparent to those of ordinary skill in the art that modifications could readily be made, such as by combining magnets and camshafts, modifying proportions, or otherwise without departing from the scope or spirit of the invention.

1. A chord-pressing device for a stringed instrument, comprising:
a support base configured for removable attachment to a neck of said stringed instrument;
a plurality of camshafts rotatably mounted atop said support base;
a plurality of eccentric lobes mounted on each of said camshafts;
a plurality of motors mounted atop said support base each coupled to a respective camshaft for indexed rotation of said lobes; and
a plurality of pistons each engageable by a corresponding lobe and thereby extendable beneath said support base for biasing a string against a fret of said stringed instrument.

2. The chord-pressing device according to claim 1, wherein said plurality of camshafts are parallel.

3. The chord-pressing device according to claim 1, wherein said plurality of pistons are each spring-biased.

4. The chord-pressing device according to claim 1, wherein said plurality of pistons are slidably captive in a corresponding plurality of sleeves.

5. The chord-pressing device according to claim 1, wherein said plurality of motors comprises servo motors.

6. The chord-pressing device according to claim 2, further comprising a microcontroller for driving said servo motors.

7. The chord-pressing device according to claim 6, further comprising a software application executable by said microcontroller for actuating said servo motors to automate chord-pressing while a user strums said stringed instrument.

8. The chord-pressing device according to claim 7, further comprising a plurality of sensors each mounted proximate a corresponding string of said musical instrument and in communication with said microcontroller to monitor string vibration when a user strums said stringed instrument.

9. The chord-pressing device according to claim 8, wherein said software application establishes chord transitions for driving said servo motors as a function of said plurality of sensors.

10. The chord-pressing device according to claim 9, wherein said software application is selectively programmable to initiate single chord transitions after each instance of said user strumming said stringed instrument, or alternatively at a predetermined tempo.

11. The chord-pressing device according to claim 9, wherein said software application is selectively programmable to initiate single chord transitions, a user-selected sequence of chords, or a user-selected song.

12. A chord-pressing device for a stringed instrument, comprising:
a support base configured for removable attachment to the neck of said stringed instrument;
a plurality of magnets mounted atop said support base; and
a plurality of pistons protruding beneath said support base each for biasing a string against a fret of said stringed instrument when magnetically-engaged by one of said magnets.

13. The chord-pressing device according to claim 12, wherein said plurality of magnets are electromagnets.

14. The chord-pressing device according to claim 12, wherein said plurality of pistons are each spring-biased.

15. The chord-pressing device according to claim 12, wherein said plurality of pistons are slidably captive in a corresponding plurality of sleeves.

16. The chord-pressing device according to claim 13, further comprising a microcontroller for actuating said electromagnets.

17. The chord-pressing device according to claim 16, further comprising a software application executable by said microcontroller for actuating said electromagnets to automate chord-pressing while a user strums said stringed instrument.

18. The chord-pressing device according to claim 17, further comprising a plurality of sensors each mounted proximate a corresponding string of said musical instrument and in communication with said microcontroller to monitor string vibration when a user strums said stringed instrument.

19. The chord-pressing device according to claim 18, wherein said software application establishes chord transitions for driving said electromagnets as a function of said plurality of sensors.

20. A chord-pressing device for a stringed instrument, comprising:
a base configured for removable attachment to a neck of said stringed instrument, said base housing a plurality of actuators each configured for biasing a string against a fret of said stringed instrument;
a microcontroller in communication with said actuators; and
a software application running on said microcontroller and programmed to actuate said actuators to automate chord-pressing while a user strums said stringed instrument, said software application being configured for user selection of single chord transitions, a user-selected sequence of chords, or a user-selected song.
